(19) United States
(12) Patent Application Publication
(10) Pub. No.: US 2003/0145704 A1
(43) Pub. Date: Aug. 7, 2003

(54) Shears for cutting belt material with adjustment of cutting angle

(76) Inventor: Bernd Hoffmann, Burgkunstadt (DE)

Correspondence Address: JORDAN AND HAMBURG LLP, 122 EAST 42ND STREET, SUITE 4000, NEW YORK, NY, 10168, US

(21) Appl. No.: 10/304,972

(22) Filed: Nov. 27, 2002

(30) Foreign Application Priority Data
Jan. 16, 2002 (DE) 102 01 368.3-14

(51) Int. Cl. B26D 1/06

(52) U.S. Cl. 83/451; 83/694

(57) ABSTRACT

Shears for cutting belt material, especially corded belts, with a movable upper knife and a stationary lower knife, a discharging conveyor belt and an upstream, pivotable depositing table and a drawing-in device for the belt material, wherein a metal shifting sheet, displaceable in the conveying direction of the belt, is mounted on the depositing table between the depositing table and the belt material.

The invention relates to shears for cutting belt material, especially corded belts, with a drawing-in device and a pivotable supporting table for the belt material for changing the cutting angle.

When cutting belt material, especially when cutting unvulcanized corded belts in the tire industry, the problem of a distortion of the belt, which results in larger amounts of rejected material being obtained, arises time and again. Especially when the cutting angle is changed, the danger always exists that the belt section, which has been pulled through and rests on the discharging conveyor belt, is shifted and folded during the swiveling of the supporting table, so that the cut is not smooth and therefore new sections have to be disposed of time and again as waste, before finally the correct cutting angle is set.

It is therefore an object of the invention to design shears of the type named above, so that belt deformations, especially during the swiveling of the supporting table, are avoided and the amount of rejected material formed is decreased.

Pursuant to the invention, this objective is accomplished owing to the fact that, between the supporting table and the belt material, a metal shifting sheet is disposed, which, displaceable essentially synchronously with the drawing-in device, supports the belt material, protruding over the table and drawn in through the shears over the discharging conveyor belt behind the shears and, before the cutting, returns to its starting position on the supporting table.

By means of the inventive metal shifting sheet, the belt material, after being released by the drawing-in device, is not simply deposited on the discharging conveyor belt, but instead, during the subsequent swiveling of the let-off, remains together with the metal shifting sheet and the belt material supported thereon, on this metal shifting sheet, so that there cannot be any deformation of the belt material and, with that, there is no danger that rejected material will arise. Only after the cutting angle has been adjusted, does the metal shifting sheet move back into its starting position and then deposits the belt material, which subsequently no longer is moved and therefore cannot be deformed, on the discharging conveyor belt.

In order to ensure this supporting function optimally, the metal shifting sheet, if it is sufficiently stiff and if there is sufficient space at the rear, can protrude a little beyond the belt material in the pushed-out end position.

In order to be able to support, as far as possible, the whole of the leading end of the belt material, the metal shifting sheet may have a beveled leading edge.

In a further development of the invention, the metal shifting sheet can be edged sinusoidally, the supporting edges of the wave crests extending parallel to the displacement direction. This construction results, not only, in a smaller contacting surface, which facilitates the retraction of the metal shifting sheet before the belt material is cut without carrying along and deforming the belt material, but also offers the possibility of facilitating this retraction even further by blowing air between the belt material and the metal shifting sheet. For this purpose, a blowing strip, fastened to the rear end of the metal shifting sheet, may be provided for blowing in air through the relatively shallow valleys of the sinusoidal metal shifting sheet. This blowing strip is activated only when the metal shifting sheet, after it has supported the belt material during it passage through the shears, is to be returned to its starting position.

It is with particular advantage that a hold-down device of the shears, for clamping the belt material curing the cutting operation, is provided with a magnetic and/or a suction strip for raising the belt material during the retraction of the metal shifting sheet. This holding device for the belt material immediately next to the later site of the cut is of particular importance for the retraction of the metal shifting sheet without the risk of distorting the material belt, which has previously been supported thereon.

Due to the inventive device, an automatic adjustment of the cutting angle is possible without distorting the material, that is, with considerable less waste, since the first cut after the adjustment of the cutting angle already is dimensionally all right, so that it is not necessary, as it was previously, to discard a few strips first due to the distortion of the material during the adjustment of the cutting angle. The waste is cut off automatically and collected in the waste container. Previously, after the adjustment of the cutting angle, the operator had to transport the waste in the manual operation of the machine into the shears, cut it off, transport it out of the shears and remove it manually from the conveyor belt.

Due to the omission of the manual operating steps of the operator during the conventional adjustment of the angle, namely the moving of the waste into the shears after the angle has been adjusted in the manual operation of the machine, the cutting off of the waste in the manual operation of the machine, the delivery of the waste in the manual operation, the manual removal of the waste from the conveyor belt and the checking of the first 5 to 10 strips after the adjustment of the angle for dimensional accuracy if the dimensional accuracy is not a given, the time saved is considerable. As a result of the time saved, the machine can be used appreciably more flexibly in production (decrease in the setup time). As a result, a product change and the processing of small lot sizes become possible more easily.

Further advantages, distinguishing features and details of the invention arise out of the following description of an example as well as from the drawing, in which

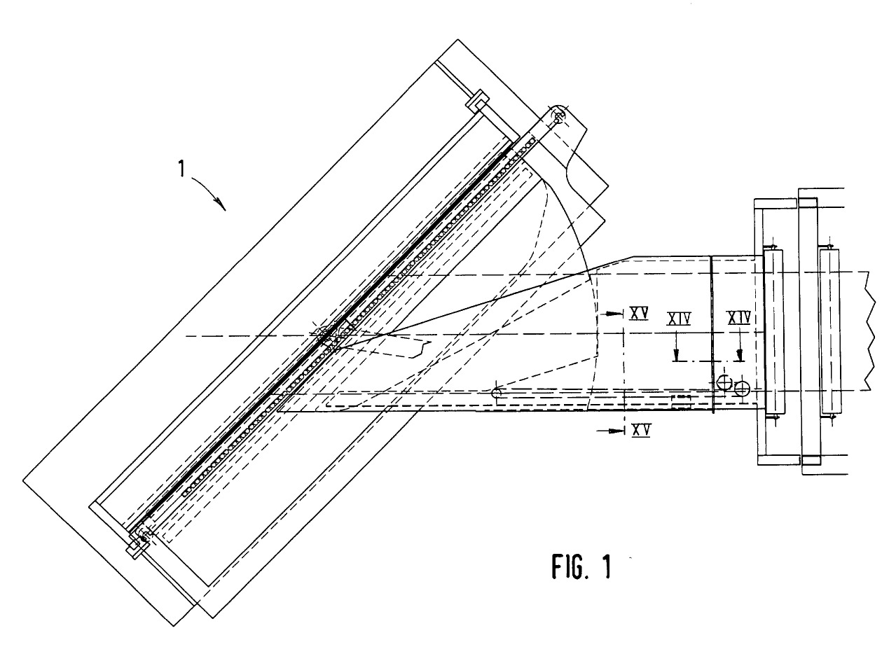

FIG. 1 shows a plan view of the inventive shears,

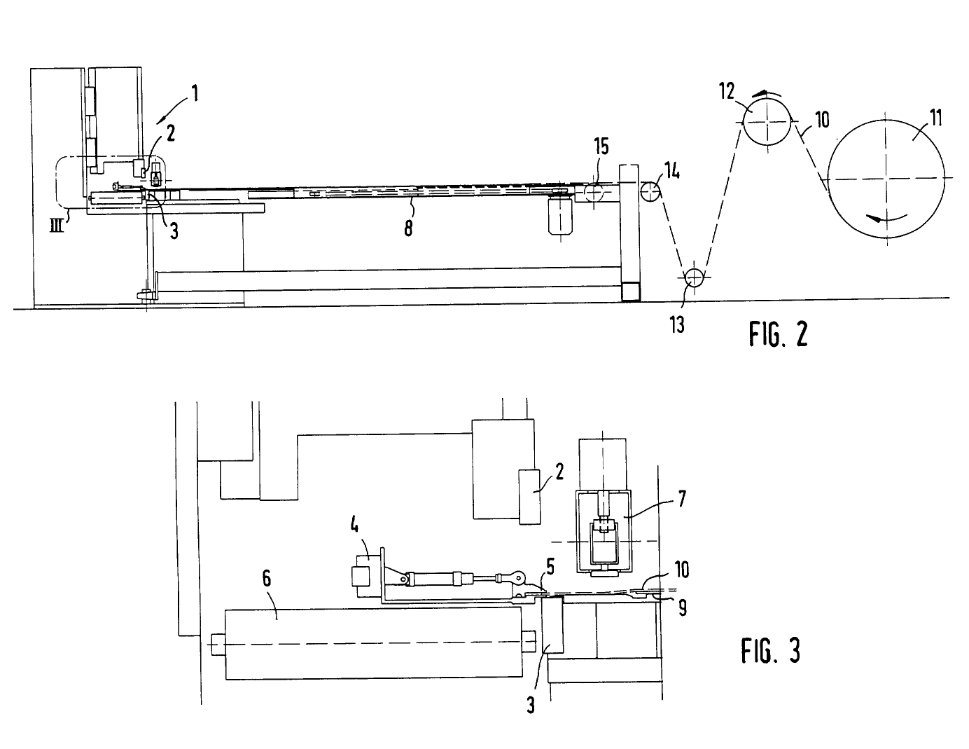

FIG. 2 shows a side view of the shears of FIG. 1,

FIG. 3 shows an enlarged detailed view of the drawing-in region III of the shears in FIG. 2,

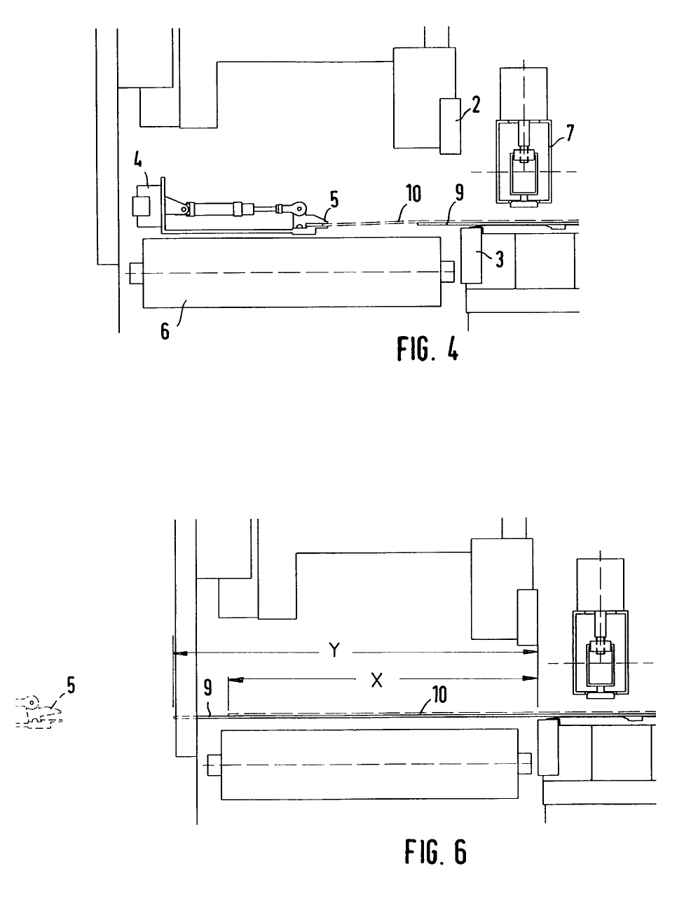

FIG. 4 shows a side view, corresponding to that of FIG. 3, during the drawing-in of the belt material supported by the metal shifting sheet, which is also shifted forwards,

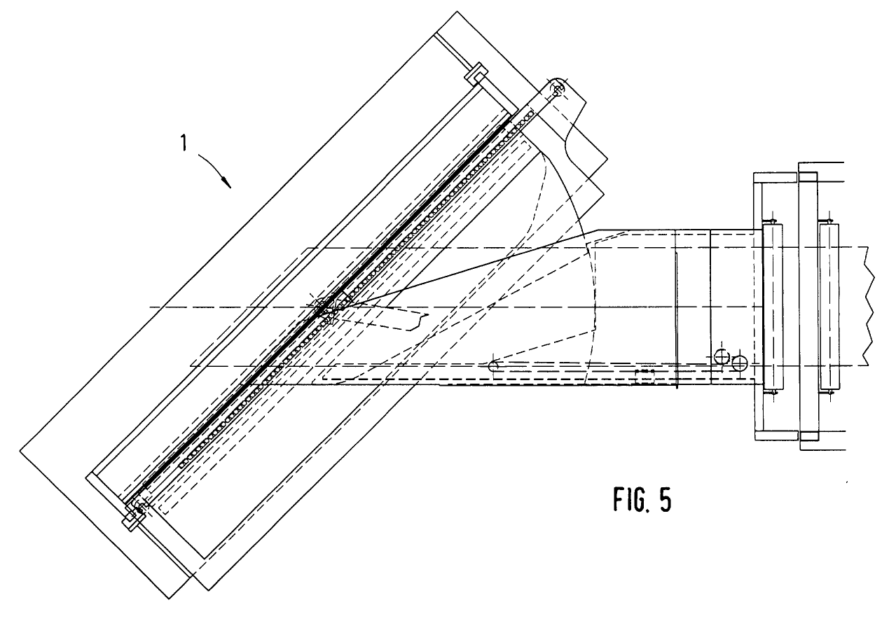

FIG. 5 shows a plan view of the shears in the operating position of FIG. 4,

FIG. 6 shows a side view, corresponding to FIGS. 3 and 4, after the belt material has been drawn in completely and released by the drawing-in device,

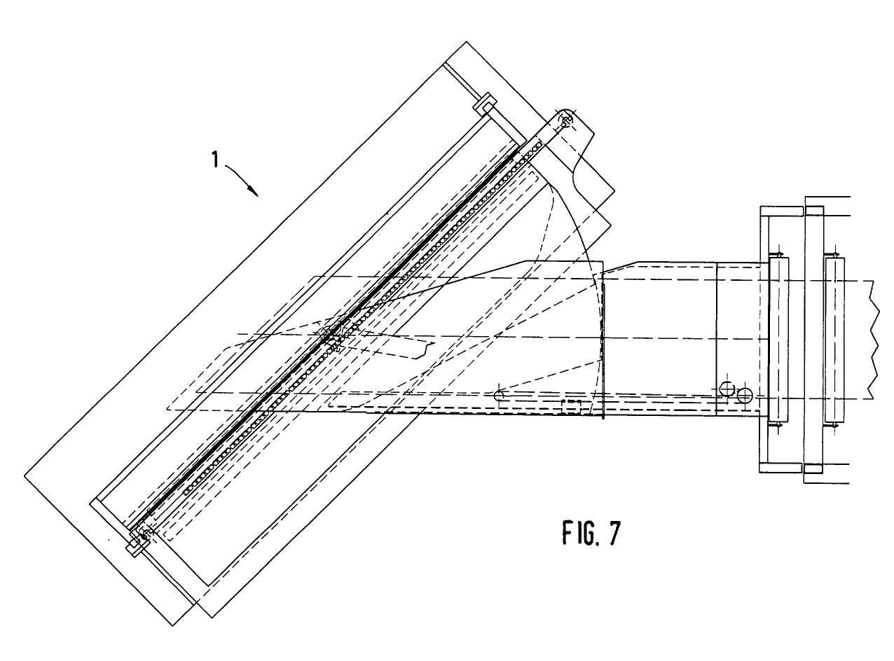

FIG. 7 shows a plan view of the shears in the operating position of FIG. 6,

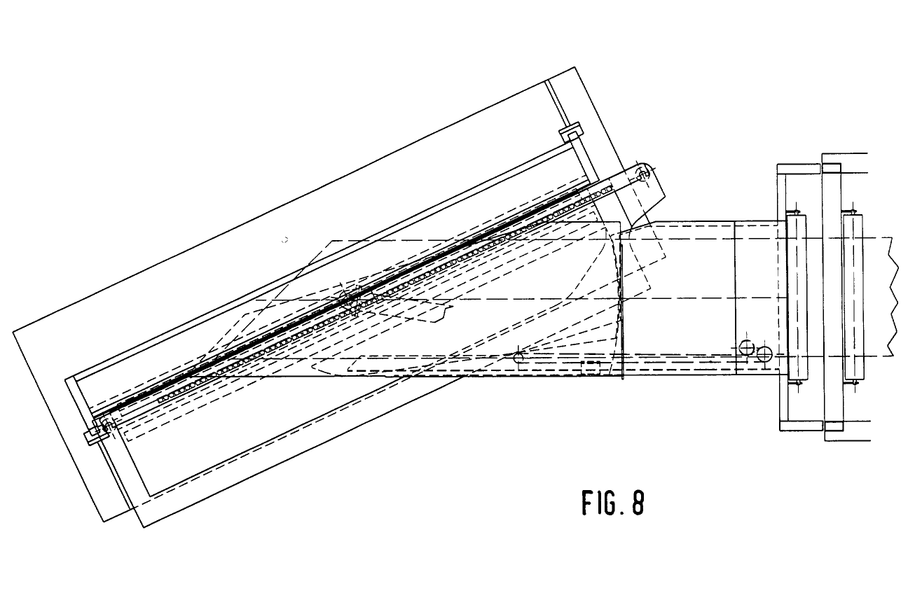

FIG. 8 shows a plan view, corresponding to FIG. 7, after the adjustment of the cutting angle to a more acute value,

FIG. 9 shows a side view of the cutting region of the shears with the extended magnetic or blowing strip of the holding-down device for lifting up the belt material during the retraction of the metal shifting sheet.

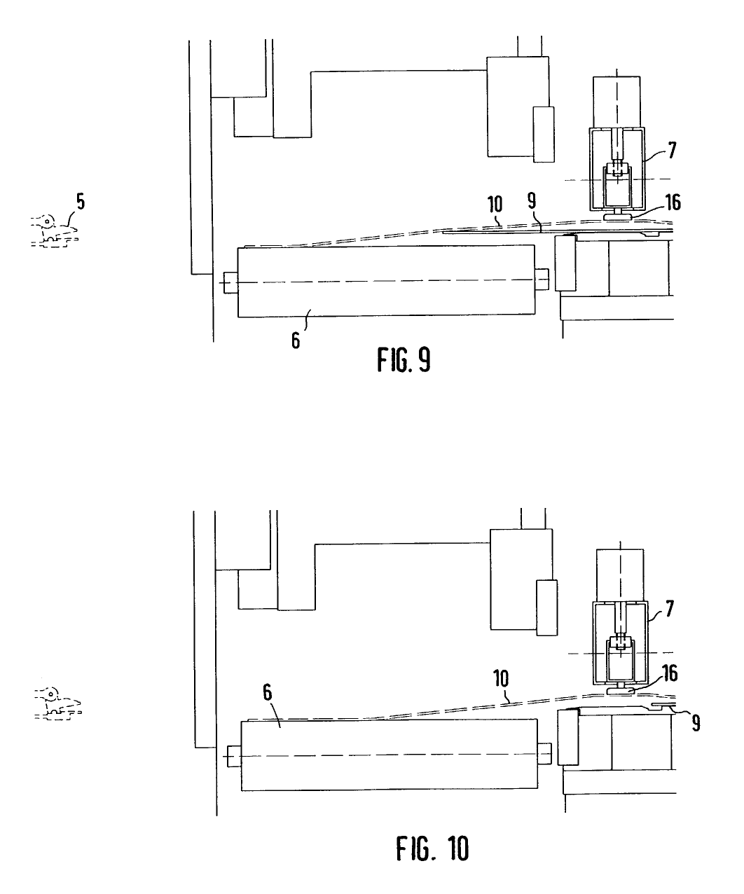

FIG. 10 shows a side view corresponding to FIG. 9, in the completely retracted position of the metal shifting sheet,

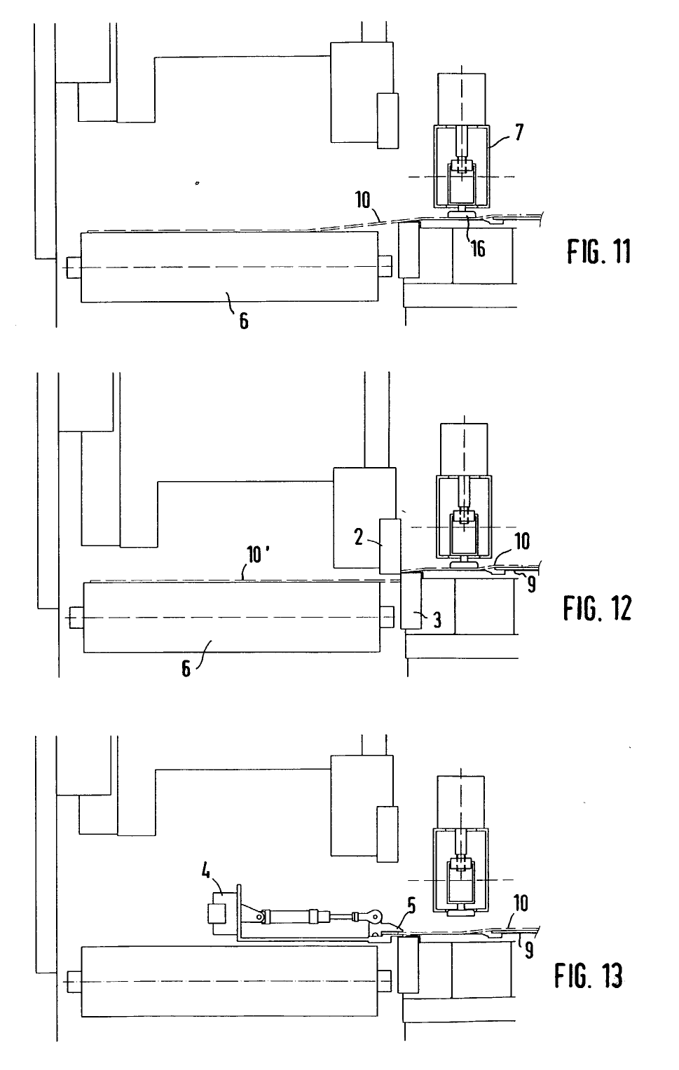

FIG. 11 shows a side view corresponding to FIGS. 9 and 10, when the holding-down device has been moved out of the way before the cutting operation,

FIG. 12 shows the side view of the shears after the cutting operation,

FIG. 13 shows a side view of the shears after the cut-off section of the belt has been transported away and the holding-down device has been elevated,

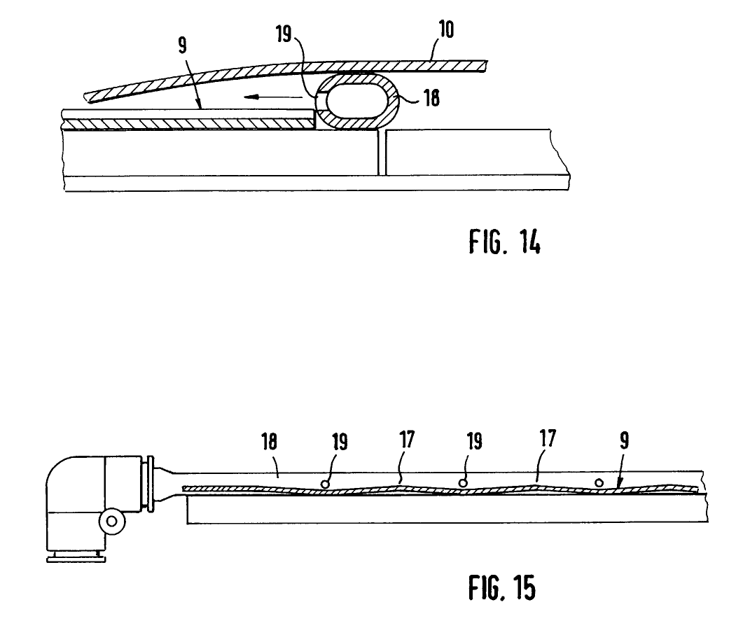

FIG. 14 shows an enlarged section along the line XIV-XIV of FIG. 1 and

FIG. 15 shows an enlarged section along the line XV-XV in FIG. 1.

FIGS. 1 to 3 show the shears 1 with the movable upper knife 2 and the stationary lower knife 3, the retraction 4 for the retracting tongs 5 for pulling the belt material through the shears, the conveyor belt 6 for transporting the cut-off sections of belt and the holding-down device away 7. In front of the shears, a depositing table 8 is disposed, on which a metal shifting sheet 9 rests so that it can be shifted between the belt material 10 and the table in the conveying direction of the belt. From the let-off 11, the belt material 10 is delivered over a deflection roller 12, a compensating roller 13 and further rollers 14, 15. For pulling the belt material 10 through the shears, the retraction tongs, in the starting position after a previous section of belt is cut off, are applied to the front end of the belt, which is pulled in initially by about 200 mm, as it is also in the case of the example shown in FIGS. 1 to 3. Subsequently—in principle, a synchronous shifting from the very start would also be possible—the metal shifting sheet 9 is shifted essentially synchronously with the pulling through of the belt material 10, so that, by way of the intermediate position of FIGS. 4 and 5, the final pushing-through position is reached, in which the belt has been pulled through so far, that the desired section of belt of length X (FIG. 6) can be cut off. At the same time, the metal shifting sheet has been pushed somewhat further forward, altogether by an amount of Y with respect to the cutting plane, so that the belt material 10 is supported as far as possible. In order to change the cutting angle from the position of FIG. 7 into the new cutting angle position of FIG. 8, the let off, the metal shifting sheet and the belt material resting thereon are swiveled jointly, without any danger of distortion during this angular adjustment.

Subsequently, as shown in FIG. 9, a magnetic or suction strip of the holding-down device 7 is extended in order to raise the belt material either by suction or by a magnetic force (in the case of steel-corded belts), so that, when the metal shifting sheet is retracted, it does not adhere thereto and is not deformed during this retraction. At the same time, as shown in FIGS. 9 and 10, the belt material is deposited on the discharging conveyor belt 6 of the shears. After the complete retraction of the metal shifting sheet into the position shown in FIG. 10, the holding-down device 7 departs and presses the belt material on the cutting table firmly (FIG. 11), so that it is fixed during the actual cutting operation (FIG. 12) and cannot be deformed. After the section of belt 10′, deposited on the conveyor belt 6, has been transported away, the retraction is activated once again in order to bring the retraction tongs into the position shown in FIG. 13, in which the holding-down device has been moved upward once again and the retraction tongs have clamped the front end of the belt material 10, so that subsequently the belt material can be pulled thorough once again in a manner corresponding to the sequence of FIGS. 1 to 12.

As can be seen, in particular, in FIGS. 14 and 15, the metal shifting sheet 9 is edged sinusoidally, the supporting edges 17 of the “wave peaks” extending parallel to the shifting direction. The wave peaks are at a distance of about 40 mm from one another, the depressions amounting only to about 2 mm. Nevertheless, due to this edging, the contacting area of this belt, resting on these peaks, is less and the shifting metal sheet is retracted more easily without deformation of the belt material. In particular, the possibility arises of blowing air over a blowing strip 18, which has been fastened to the rear end of the shifting metal sheet 9 and has air holes 19, between the belt material 10 and the shifting metal sheet 9, so that, because the belt material is raised, adhesion is prevented and, with that, the shifting metal sheet can be retracted very easily.

1. Shears for cutting belt material (10), especially corded belts, with a movable upper knife (2) and a stationary lower knife (3), a discharging conveyor belt (6) and an upstream, pivotable depositing table (8) and a drawing-in device for the belt material (10), wherein a metal shifting sheet (9), displaceable in the conveying direction of the belt, is mounted on the depositing table (8) between the depositing table (8) and the belt material (10).

2. Shears of claim 1, wherein the metal shifting sheet (9) protrudes somewhat over the belt material (10) in the pushed-out end position.

3. Shears of claims 1 or 2, wherein the shifting metal sheet (9) has a beveled front edge.

4. Shears of one of the claims 1 to 3, wherein the metal shifting sheet (9) is edged sinusoidaly, the supporting edges of the “wave peaks” extending parallel t the displacement direction.

5. Shears of one of the claims 1 to 4, wherein a blowing strip (18), fastened to the rear end of the metal shifting sheet (9), is provided for blowing air between the belt material (10) and the metal shifting sheet (9).

6. Shears of one of the claims 1 to 5, wherein the holding-down device (7) for clamping the belt material (10) during the cutting operation is provided with a magnetic strip and/or a suction strip for raising the belt material (10) during the retraction of the metal shifting sheet (9).

7. Shears of one of the claims 1 to 6, wherein the let off (11) can be swiveled together with the metal shifting sheet (9) and the belt material (10) lying thereon.
